(19) United States
(12) Patent Application Publication
(10) Pub. No.: US 2014/0068562 A1
(43) Pub. Date: Mar. 6, 2014

(54) Application Review

(71) Applicant: Syed Hamid, Redmond, WA (US)

(72) Inventor: Syed Hamid, Redmond, WA (US)

(21) Appl. No.: 13/602,162

(22) Filed: Sep. 2, 2012

(51) Int. Cl. G06F 9/44

(52) U.S. Cl. 717/124

(57) ABSTRACT

Techniques are disclosed to provide consolidated performance and other metrics for an application. In one embodiment, a package containing the application, target devices, and operating systems is received; tests are generated and run on the targeted devices and operating systems. Data is also collected from reviews of the application, and from people using the application. All of the results may be displayed in a dashboard, providing an overview of the applications subjective and objective properties.

### FIELD

This disclosure relates to application review

### BACKGROUND

Testing applications can be an expensive and time-consuming process. Many different phones, computers, and tablets are available, and an application tested on one may behave differently on another. Few developers can afford time or money to test on a representative group of all devices.

### SUMMARY OF THE INVENTION

The instant application discloses, among other things, an integrated way to provide feedback about the functioning of their applications, including results of testing,

A developer may upload a package including an application, devices the application should be tested on, and operating systems the application should be tested on. The application may then be tested on the selected devices and operating systems, and information gathered about successful runs, performance, crashes, and other metrics of interest.

Furthermore, data about the application may be obtained from various marketplaces the application is sold and other places the application may be reviewed, and statistics may be provided about ratings and comments made. Additional data may be obtained from customers using the application, providing information about performance, crashes, or other metrics of interest.

The various sources of data may be consolidated and displayed via a dashboard, which may allow a developer to get a good overview of the application's strengths, weaknesses, and the perceptions people have of the application.

### BRIEF DESCRIPTION OF THE DRAWINGS

FIG. 1 is an example of a system capable of supporting Application Review.

FIG. 2 is a flowchart of one embodiment of Application Review.

FIG. 3 is an example of a system capable of supporting obtaining live data for Application Review.

FIG. 4 is an example of a system capable of supporting obtaining feedback data for Application Review.

FIG. 5 illustrates a component diagram of a computing device according to one embodiment.

### DESCRIPTION OF THE INVENTION

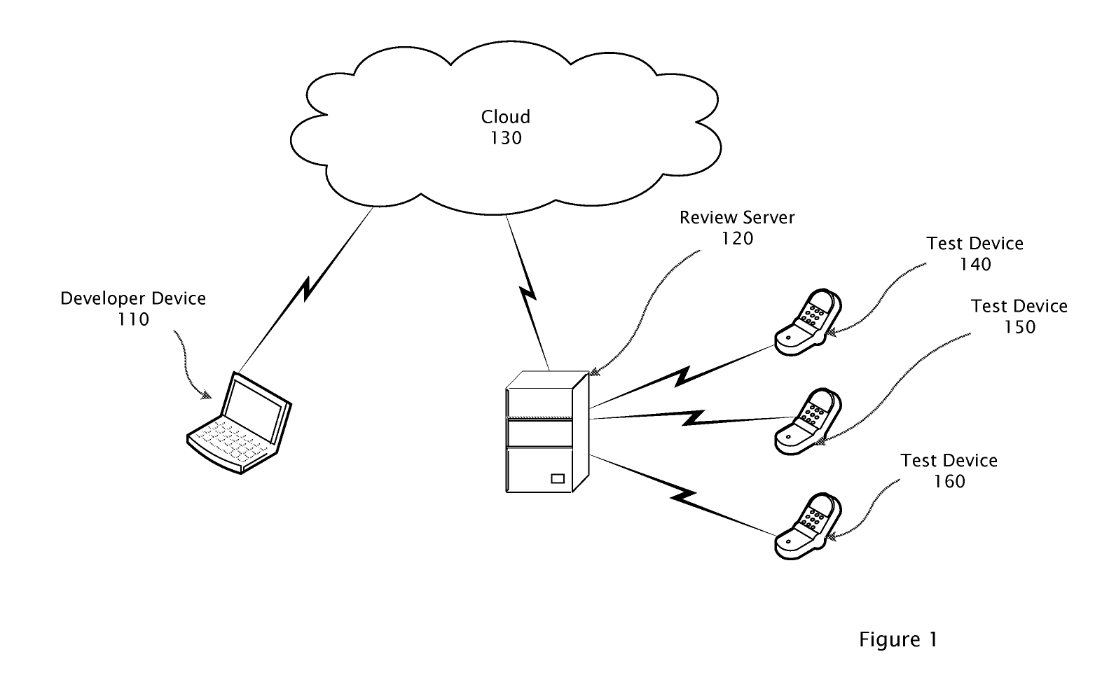

FIG. 1 is an example of a system capable of supporting Application Review. In this example, a Developer Device 110 may upload a package to Review Server 120 via cloud 130. The upload package may request testing on two models of devices, and two operating systems on one of the models. Thus Test Device 140 may be one model, and Test Devices 150 and 160 may be another model, with Test Device 140 and 150 running one operating system and Test Device 160 running a different operating system. Test Devices 150 may be cellular telephones, laptop computers, gaming consoles, desktop computers, workstations, server computers, or any other devices capable of running applications.

Review Server 120 may examine the package, and determine which devices and operating systems to use for testing. Review Server 120 may further examine the application and determine what actions may be testable, and generate tests to execute those actions. Review Server 120 may then upload the application and the generated tests to Test Devices 140, 150, and 160, tracking the results of the tests, any crashes that may occur, performance metrics, or any other metrics that are desired.

Review Server 120 may comprise one or more Computing Devices 1300.

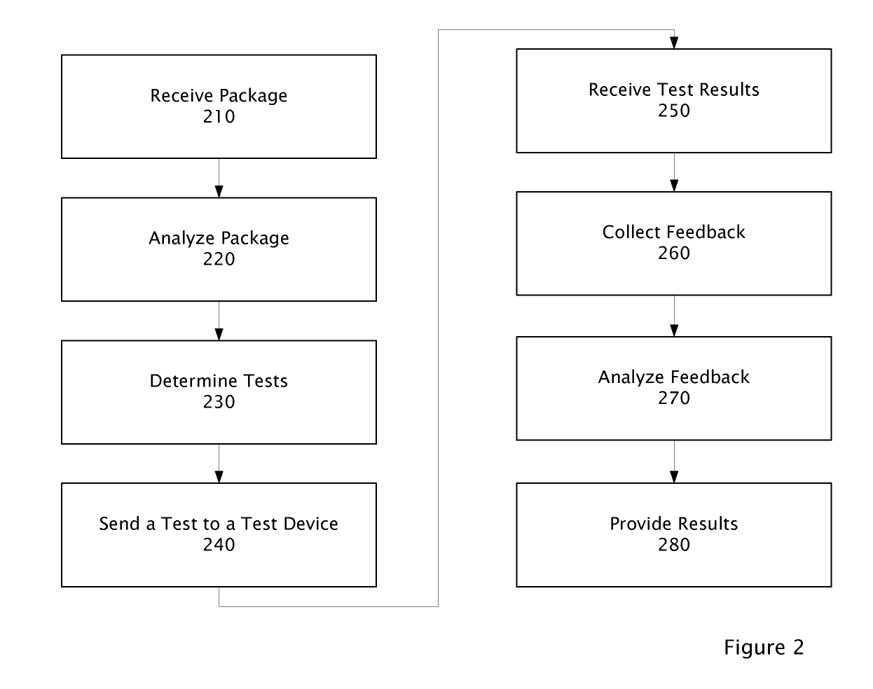

FIG. 2 is a flowchart of one embodiment of Application Review. In this embodiment, Review Server 120 Receives a Package 210 from a Developer Device 110. Review Server 120 Analyzes the Package 220, which contains an application and information about what devices and operating systems on which the application is to be tested. The package may also contain indications of specific tests to be run. The Tests are Determined 230, which may be based on randomly exercising features of the application, may be based on the specific tests requested, or may be based on a combination of the two.

Review Server 120 may then Send a Test to Test Device 240. By way of example and not limitation, this may be done by wired connections, such as USB, or wirelessly by wireless networking or Bluetooth. Send a Test to a Test Device 240 may also include sending the application to the test device. Review Server 120 may also instruct the test device to install the application, and to execute the test.

Review Server may Receive Test Results 250 from the test device. Results may include test failures, application hangs, performance metrics, and other metrics that may be of interest.

Review Server 120 may also Collect Feedback 260. For example, Review Server 120 may obtain review scores and comments about the application from various online marketplaces, review sites, hardware vendor sites, and any other sources as appropriate. Review Server 120 may Analyze Feedback 270 from these various sources and may, for example, calculate average review scores, may do text analysis on comments, and perform other analyses to obtain information about facts and perceptions about the application.

Review Server 120 may Provide the Results 280 from the testing and feedback. This may be done by a website, email, reports, or other ways of communicating.

Review Server 120 may Provide Results 280 so that a developer may see the test results.

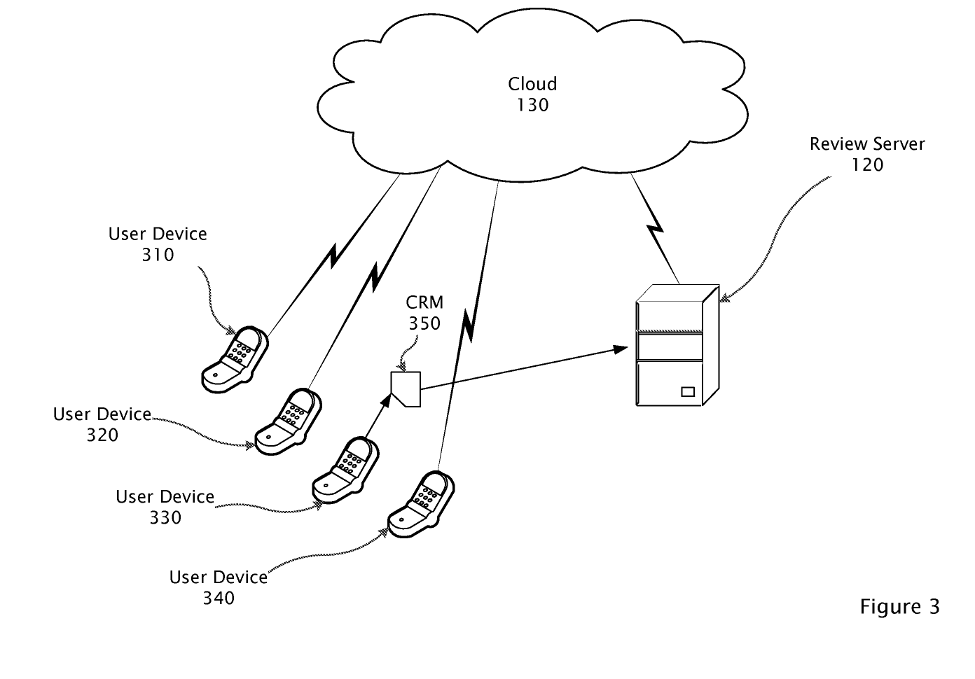

FIG. 3 is an example of a system capable of supporting obtaining live data for Application Review. In this example, User Devices 310, 320, 330, and 340 may send data about an application to Review Server 120. The data may be sent via an internet, network, Bluetooth, or other computer readable media. In this example, User Device 350 may write data collected to CRM 350, which may be, for example, an SD card. CRM 350 may be read by Review Server 120 to obtain the data.

One having skill in the art will recognize that many techniques may be used to transfer data from one device to another.

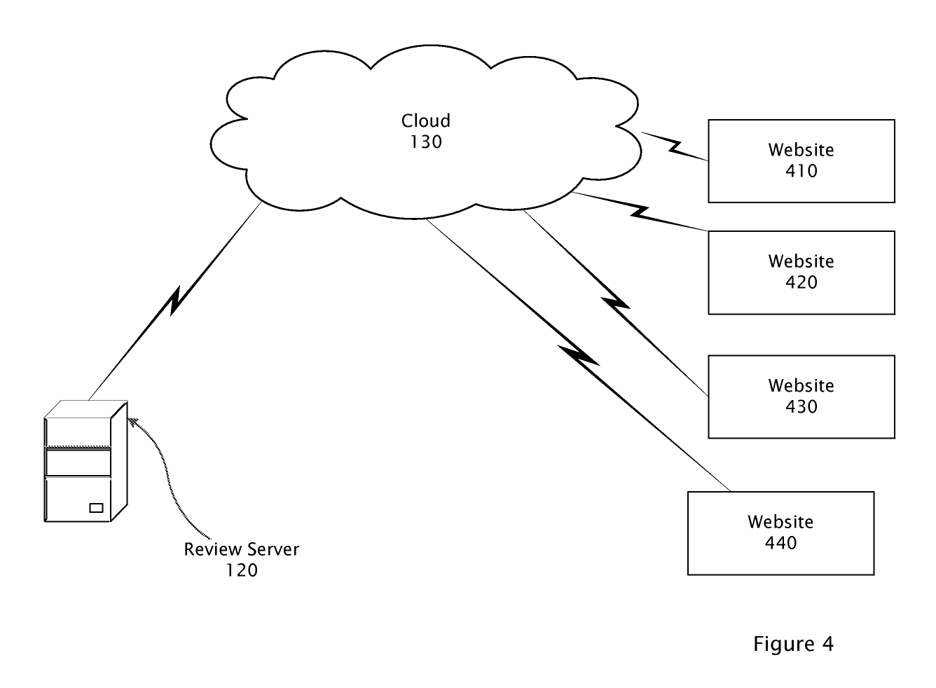

FIG. 4 is an example of a system capable of supporting obtaining feedback data for Application Review. In this example, Review Server 120 may access Websites 410, 420, 430, and 440 to obtain reviews about an application. Review Server 120 may consolidate data from these websites and calculate statistics, analyze comments, or perform other processing to obtain information that may be of interest to a developer of the application.

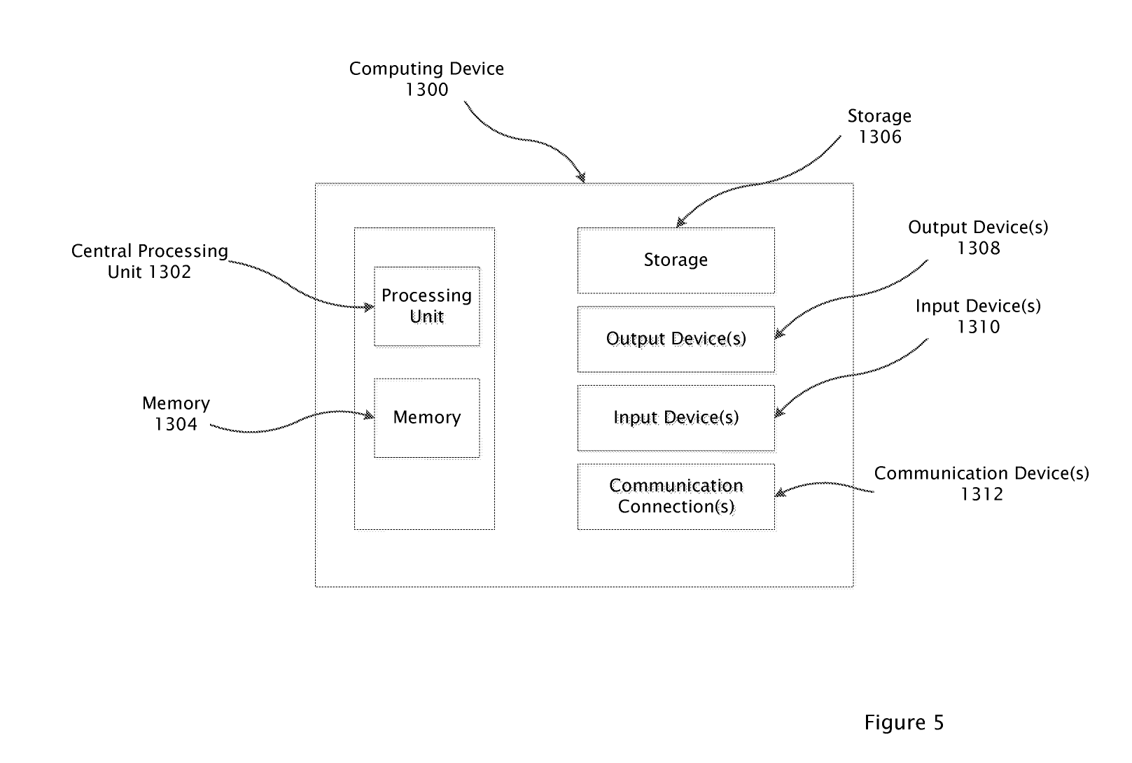

FIG. 5 illustrates a component diagram of a computing device according to one embodiment. The computing device (1300) can be utilized to implement one or more computing devices, computer processes, or software modules described herein. In one example, the computing device (1300) can be utilized to process calculations, execute instructions, receive and transmit digital signals. In another example, the computing device (1300) can be utilized to process calculations, execute instructions, receive and transmit digital signals, receive and transmit search queries, and hypertext, compile computer code as required by a Server or a Client. The computing device (1300) can be any general or special purpose computer now known or to become known capable of performing the steps and/or performing the functions described herein, either in software, hardware, firmware, or a combination thereof.

In its most basic configuration, computing device (1300) typically includes at least one central processing unit (CPU) (1302) and memory (1304). Depending on the exact configuration and type of computing device, memory (1304) may be volatile (such as RAM), non-volatile (such as ROM, flash memory, etc.) or some combination of the two. Additionally, computing device (1300) may also have additional features/functionality. For example, computing device (1300) may include multiple CPU's. The described methods may be executed in any manner by any processing unit in computing device (1300). For example, the described process may be executed by both multiple CPU's in parallel.

Computing device (1300) may also include additional storage (removable and/or non-removable) including, but not limited to, magnetic or optical disks or tape. Such additional storage is illustrated in FIG. 8 by storage (1306). Computer storage media includes volatile and nonvolatile, removable and non-removable media implemented in any method or technology for storage of information such as computer readable instructions, data structures, program modules or other data. Memory (1304) and storage (1306) are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device (1300). Any such computer storage media may be part of computing device (1300).

Computing device (1300) may also contain communications device(s) (1312) that allow the device to communicate with other devices. Communications device(s) (1312) is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer-readable media as used herein includes both computer storage media and communication media. The described methods may be encoded in any computer-readable media in any form, such as data, computer-executable instructions, and the like.

Computing device (1300) may also have input device(s) (1310) such as keyboard, mouse, pen, voice input device, touch input device, etc. Output device(s) (1308) such as a display, speakers, printer, etc. may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

Additionally, the illustrated operations in the description show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples and data provide a complete description of the manufacture and use of the invention.

1. A method for reviewing an application, comprising:
receiving a package from a first device, the package including an application, and specifying a second device and an operating system on which to test an application;
analyzing the package;
generating a test based upon results of the analysis;
sending the generated test to the second device;
instructing the second device to execute the test;
receiving results related to the execution of the test from the second device; and
reporting the received results.

2. The method of claim 1 further comprising sending an application to the second device.

3. The method of claim 1 wherein the second device is a cellular phone.

4. The method of claim 1 wherein the generating a test comprises:
analyzing the application to determine at least one testable feature; and
producing a test to randomly exercise the at least one testable feature.

5. The method of claim 1 wherein the generating a test comprises generating at least one test to test at least one feature specified in the package.

6. The method of claim 1 further comprising:
receiving data from a plurality of devices running the application, the received data including performance metrics;
consolidating the received data, giving consolidated data; and
reporting the consolidated data.

7. A system comprising:
a processor;
a memory coupled to the processor;
a package receiving component configured to receive a package;
an analysis component configured to analyze the received package, giving an analysis;
a test determination component configured to determine a test based upon the analysis;
a test sending component configured to send the test to a device;
a device control component configured to instruct the device to execute the test; and
a test result receiving component configured to receive test results from the device.

8. The system of claim 7 further comprising a test result output component configured to output the received test results.

9. The system of claim 8 wherein outputting the received test results comprises generating HTML to display the results.

10. The system of claim 8 wherein outputting the received test results comprises generating an email comprising the results.

11. The system of claim 7 further comprising:
a feedback collection component configured to obtain feedback about the application from at least one computer-readable source;
a feedback analysis component configured to analyze collected feedback; and
a feedback analysis output component, configured to output feedback analysis.

12. The system of claim 11 wherein outputting the received test results comprises generating HTML to display the results.

13. The system of claim 11 wherein outputting the received test results comprises generating an email comprising the results.

14. A computer-readable storage media containing instructions stored thereon which, when executed by a processor, perform a method comprising:
receiving a package from a first device, the package including an application, and specifying a second device and an operating system on which to test an application;
analyzing the package;
generating a test based upon results of the analysis;
sending the generated test to the second device;
instructing the second device to execute the test;
receiving results related to the execution of the test from the second device; and
reporting the received results.

15. The method of claim 13 further comprising sending an application to the second device.

16. The method of claim 13 wherein the second device is a cellular phone.

17. The method of claim 13 wherein the generating a test comprises:
analyzing the application to determine at least one testable feature; and
producing a test to randomly exercise the at least one testable feature.

18. The method of claim 13 wherein the generating a test comprises generating at least one test to test at least one feature specified in the package.
